(19) United States
(12) Patent Application Publication
(10) Pub. No.: US 2008/0052297 A1
(43) Pub. Date: Feb. 28, 2008

(54) User-Editable Contribution Taxonomy

(76) Inventor: Terry LeClair, Fremont, CA (US)

Correspondence Address: GUNNISON, MCKAY & HODGSON, L.L.P., 1900 GARDEN ROAD, SUITE 220, MONTEREY, CA, 93940, US

(21) Appl. No.: 11/467,496

(22) Filed: Aug. 25, 2006

(51) Int. Cl. G06F 17/00

(52) U.S. Cl. 707/100

(57) ABSTRACT

Database users can extend the database schema and associated taxonomy without requiring use of a database administration view. A system includes a server computer for communicating with users of the system, a taxonomy database for storing records having attributes and values forming the taxonomy, and a taxonomy engine for enabling the addition by users of attributes and values associated with nodes in the taxonomy database. A record is displayed to a user, for example as the result of a database search. The user indicates that she wishes to extend the database schema and add to the taxonomy, supplying the new attribute and value. The supplied attribute and value are received by the server and provided to the taxonomy engine. The taxonomy engine adds the new attribute to the schema and associates the supplied value with the attribute for the record in which the request originated.

### BACKGROUND

The present invention relates to a user-editable contribution taxonomy.

A taxonomy is a node based organizational database schema for parent and child records with attributes associated with each level and for which observational instance records can be associated. It can also be described as a node/leaf/attribute database schema. Database creation involves a design phase in which a software architect creates a schema for the database. The logical schema defines attributes that exist within an entity as well as the relationship between entities in the database. The mapping of these entity relationships for a taxonomy include the mapping of child nodes to parent nodes and the mapping of attribute entities at each node level. Once the schema is defined, individual records within the database can be created and populated with values for each available attribute. Database design is described in detail in references such as Date, C. J., “An Introduction to Database Systems,” 8th Ed., Addison Wesley 2003.

Once a schema has been created, modifying it typically requires a database administrator to use an administrative mode to add, change, or remove attributes and relationship definitions. Further, the database administrator typically uses a data manipulation language (DML) either directly or through a graphical user interface to modify the schema. For example, some databases such as Intuit's QuickBase database allow users with sufficient access rights to make changes to the schema by first switching to a design view of the database and then entering any changes.

### SUMMARY

In various embodiments, the present invention provides methods and systems for allowing database users to extend the database schema and associated taxonomy without requiring use of a database administration view. One embodiment of a system includes a server computer for communicating with users of the system, a taxonomy database for storing records having attributes and values forming the taxonomy, and a taxonomy engine for executing SQL logic on the taxonomy database and enabling the addition by users of attributes and values associated with nodes in the taxonomy database, as well as searching the database to locate records matching specified attribute values. In one embodiment of a method, a record is displayed to a user, for example as the result of a database search. The user indicates that she wishes to extend the database schema and add to the taxonomy, supplying the new attribute and value. Alternatively the user indicates that she wishes to extend the taxonomy by providing a new value for an already existing attribute. The supplied new attribute and value are received by the server and provided to the taxonomy engine. In one embodiment, the taxonomy engine confirms that the user has permission to make the data addition she is attempting to make before the addition is actually performed. The taxonomy engine then adds the new attribute to the schema and associates the supplied value with the attribute for the record in which the request originated. Other records that now include the new attribute are displayed subsequently to users without a value, and users are in one embodiment invited to contribute values for the attributes.

### BRIEF DESCRIPTION OF THE DRAWINGS

FIG. 1 is an illustration of an embodiment of a system for extending a database schema.

FIG. 2 illustrates an example of a taxonomy.

FIG. 3 through FIG. 8 illustrate embodiments of a user interface for extending a database schema.

FIG. 9 is an illustration of a method for extending a database schema.

FIG. 10 illustrates an example of a user-extended taxonomy.

FIG. 11 is an illustration of a method for extending a database schema including analysis of user submitted values.

One skilled in the art will readily recognize from the following discussion that alternative embodiments of the structures and methods illustrated herein may be employed without departing from the principles of the invention described herein.

### DETAILED DESCRIPTION OF THE EMBODIMENTS

The present invention enables a user to contribute to a logical taxonomy and extend a database schema from within a record, without requiring the user to switch to a database administration mode. Modifications and additions of attributes are automatically made to the schema and to existing records in the database without requiring additional administration.

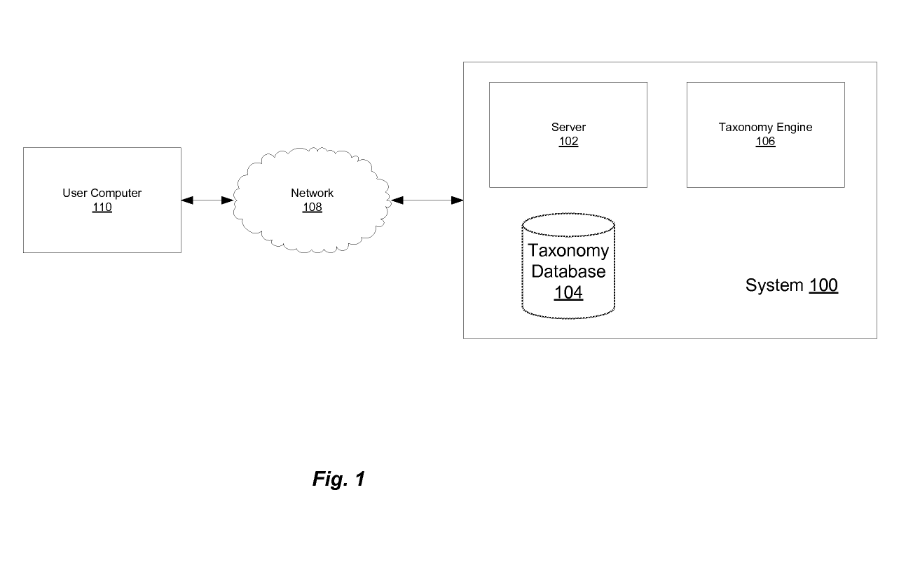

FIG. 1 illustrates an embodiment of a system 100 for providing a user-editable taxonomy and extendable database schema. System 100 includes a server 102, a taxonomy engine 106, and a taxonomy database 104. Also shown is a user computer 110. The user computer 110 includes a processor, an addressable memory, and other conventional features (not illustrated) such as a display, local memory, input/output ports, and a network interface. In some embodiments, one or more of the components of computer 110 may be located remotely and accessed via a network. User computer 110 communicates with server 102 over a network 108 such as a wired or wireless network, a LAN, MAN, WAN, the Internet, or a combination of networks, or other medium capable of supporting communication between two or more computing systems. In various embodiments the user computer 110 may be implemented on a computer running a Microsoft operating system, Mac OS, various flavors of Linux, UNIX, Palm OS, and/or other operating systems capable of virtualizing the underlying hardware to an application running on a computer. In embodiments in which user computer 110 is in communication via a network with server 102, user computer 110 runs a web browser such as Microsoft Internet Explorer, Mozilla Firefox, the Opera browser, or other browser, or application capable of displaying and interacting with text, images and other information typically located on a web page. In other embodiments, the taxonomy engine 106 is executed directly on user computer 110 rather than being accessed via web browser. Sever 102 is in communication with user computer 110 as described, providing an interface between the user computer 110 and taxonomy engine 106. In one embodiment server 102 is a web server, executing web server software such as the Apache Software Foundation Apache Server or the Microsoft Internet Information Service.

Taxonomy engine 106 includes logic for executing SQL logic on taxonomy database 104. Taxonomy engine 106 enables the addition by users of attributes and values associated with nodes in taxonomy database 104, as well as searching the database 104 for records having specified attribute values.

Taxonomy database 104 may be a relational database or any other type of database that stores the data usable by the taxonomy engine 106. Taxonomy engine 106, taxonomy database 104, and server 102 may be stored and operated on a single computer or on separate computer systems communicating with each other through a network.

One skilled in the art will recognize that the system architecture illustrated in FIG. 1 is merely exemplary, and that the invention may be practiced and implemented using many other architectures and environments.

The ability to extend the schema and add to the logical taxonomy from within a record allows a user of the database to remain in the context of the particular record being viewed while still making changes to the underlying schema, as opposed to having to switch to a database editing view and then modifying the schema.

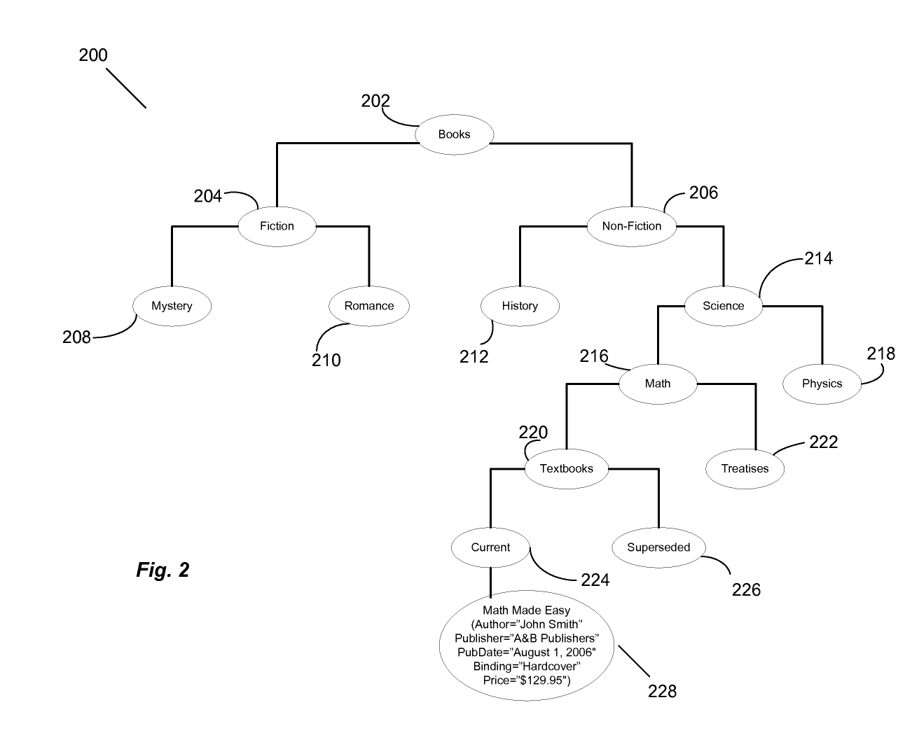

FIG. 2 is an illustration of a taxonomy 200 for providing book descriptions that can be implemented using system 100. The taxonomy could be used, for example, for cataloguing inventory in a library or book store. Base node 202 provides an anchor for the taxonomy, in this case including the value “Books”. At the next level, books are either fiction 204 or non-fiction 206. Fiction books are either mysteries 208 or romance novels 210. As will be clear to those of skill in the art, the illustrated taxonomy of FIG. 2 presents only a fraction of the nodes that would be used in an actual implementation in order to keep the example to a useful size; the simplification is not intended to limit the scope of the invention. For example, there are many other types of fiction books (science fiction, westerns, thrillers, etc.), which are not included in FIG. 2 but would likely be included in an actual taxonomy implementation. In addition, those of skill in the art will readily recognize that system 100 can be implemented using multiple taxonomies.

Continuing, non-fiction books include, for example, history books 212 and science books 214. Science books include math books 216 and physics books 218. Math books may be textbooks 220 or treatises 222, and textbooks are current 224 or superseded 226. Node 228 is a leaf node containing a record for a book titled “Math Made Easy”. Additional attributes include the book's author, publisher, publication date, binding, and price.

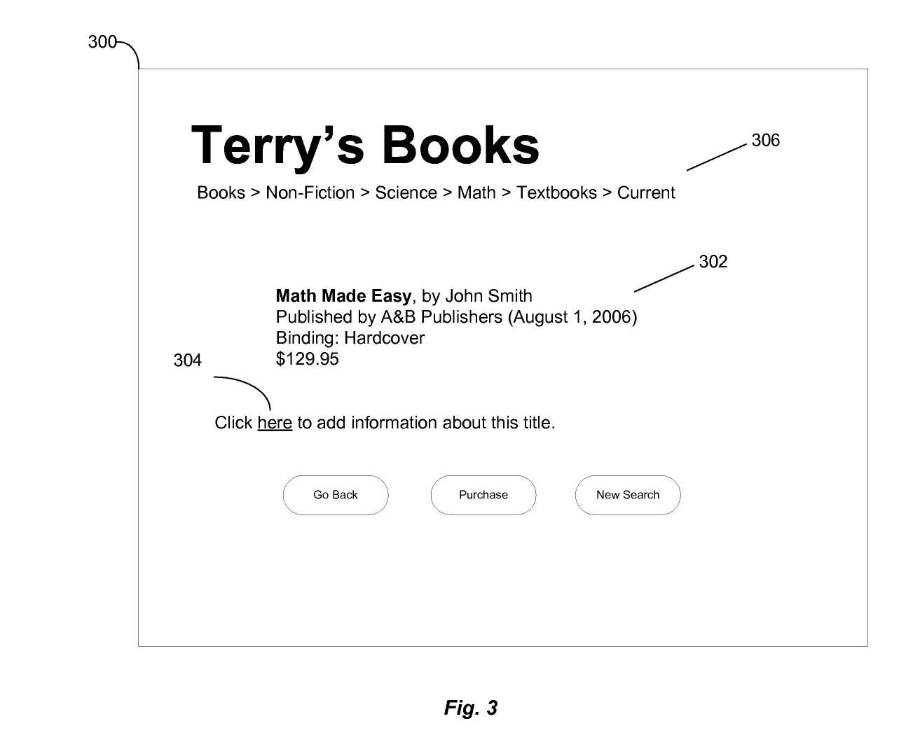

FIGS. 3-8 illustrate an embodiment of a user interface (UI) page 300 for extending a database schema. In the illustrated embodiment, UI 300 is a web page provided by web server 102 to a web client executed on user computer 110. The illustrated web page belongs in this example to Terry's Books, a fictitious retailer of books. A user of user computer 110 has navigated to the illustrated web page, for example by searching directly for a book title, or by browsing through a list of subjects. The page 300 displayed describes in region 302 the title “Math Made Easy”, by John Smith. The record for “Math Made Easy” corresponds to node 228 of FIG. 2, and is transmitted to user computer 110 after being retrieved from taxonomy database 104. In addition, the category hierarchy described in region 306 mimics the logical taxonomy illustrated in FIG. 2. As will be appreciated by those of skill in the art, FIG. 3 portrays the display of a record from taxonomy database 104. In practice, additional information and links might be included as appropriate for an e-commerce web site.

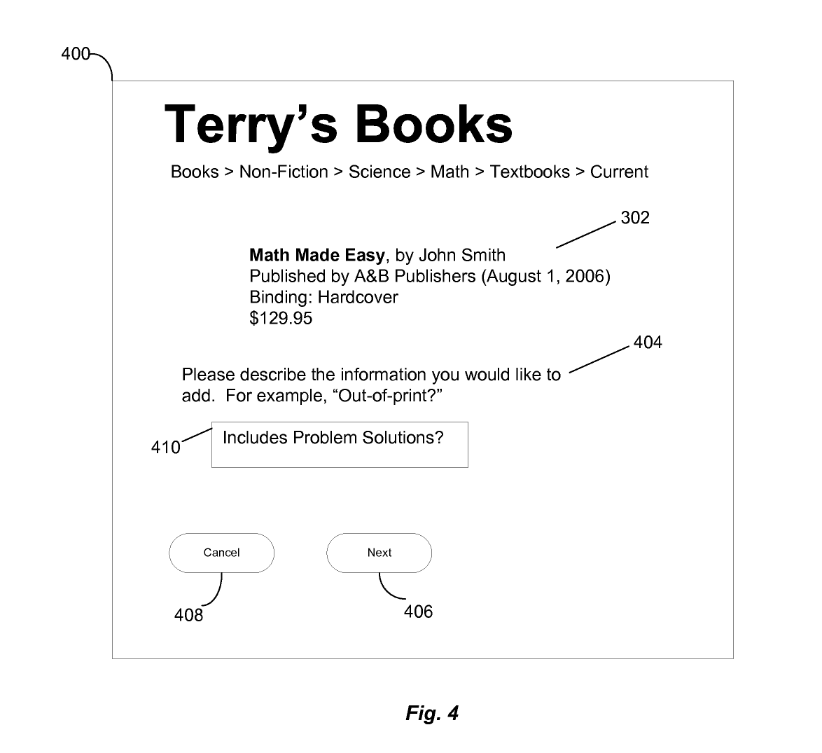

FIG. 3 also includes a link 304 that a user is invited to click in order to add information about a title, i.e. to extend the database schema. FIG. 4 illustrates an embodiment of a user interface screen 400 that is displayed when a user clicks on link 304. In region 404 of FIG. 4, the user is asked to describe in text box 410 the information she would like added to book information, i.e. an attribute to be added to the schema. In the illustrated example, the user has entered an attribute of “Includes Problem Solutions”. The user can then select a Next button 406 to continue or a Cancel button 408 to cancel the process.

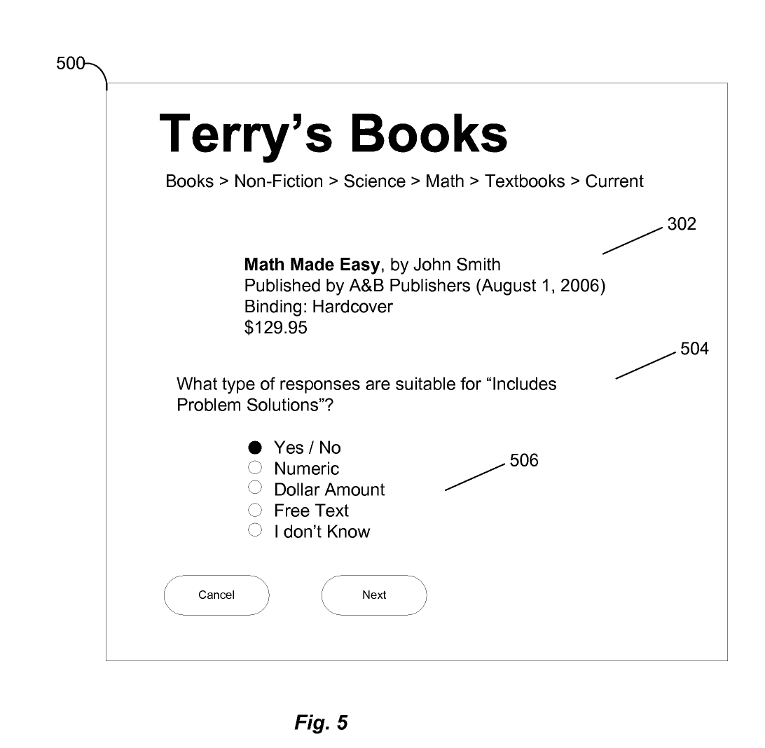

Next, and as illustrated in FIG. 5, the user is asked 504 to define a type of valid response values for the new attribute. Illustrated attribute types 506 include “Yes/No”, a numeric type, a dollar amount, or a free text response. A user can also indicate that she does know the correct type which, in one embodiment, flags the entry for review by a system administrator of system 100 who can manually determine a correct type. In FIG. 5, the user has indicated that the correct type is “Yes/No”.

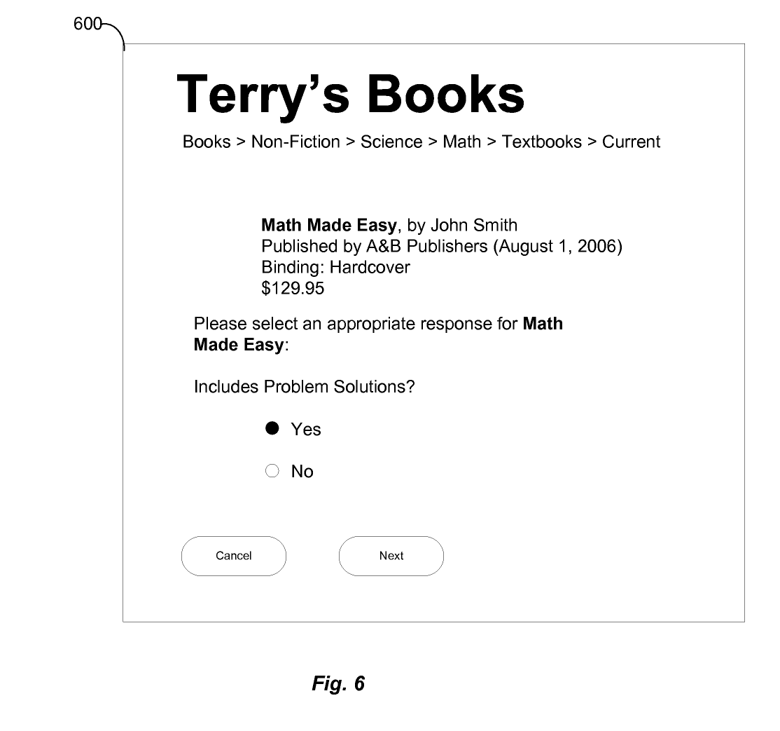

In FIG. 6, the user is asked to provide a value of the type indicated and for the attribute provided. In the illustrated case, the user has selected “Yes”, meaning that for the “Math Made Easy” record, the attribute of “Includes Problem Solutions” should have the value “Yes”.

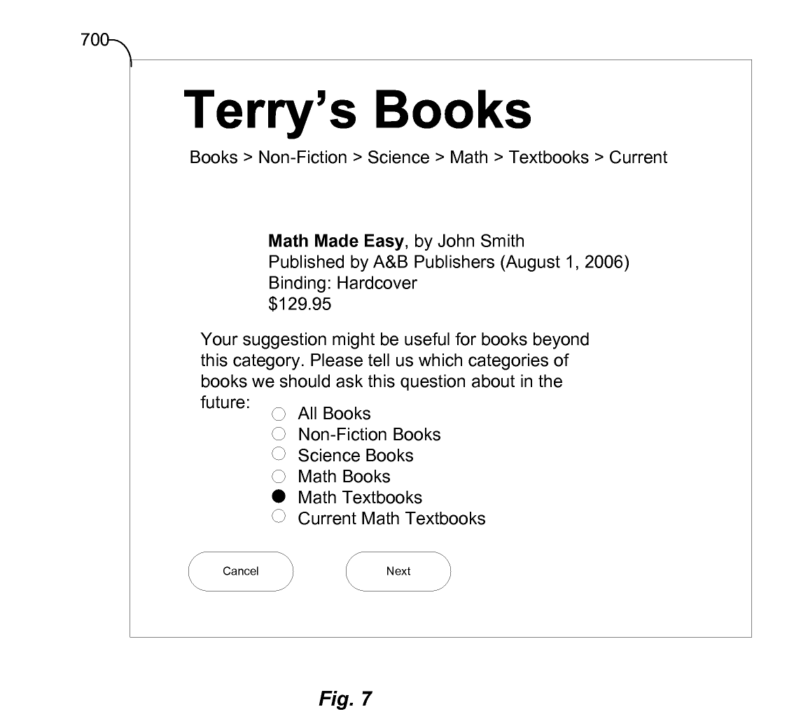

Next, in FIG. 7, the user is asked how broadly the attribute should be defined. That is, given the logical schema of the database, the user is asked at which level in the schema the attribute should be introduced. In this case, the user has indicated that “Math Textbooks” is the appropriate level. As can be seen from the taxonomy illustrated in FIG. 2, this means that the attribute should be added to all textbooks 220, including current 224 and superseded 226 textbooks.

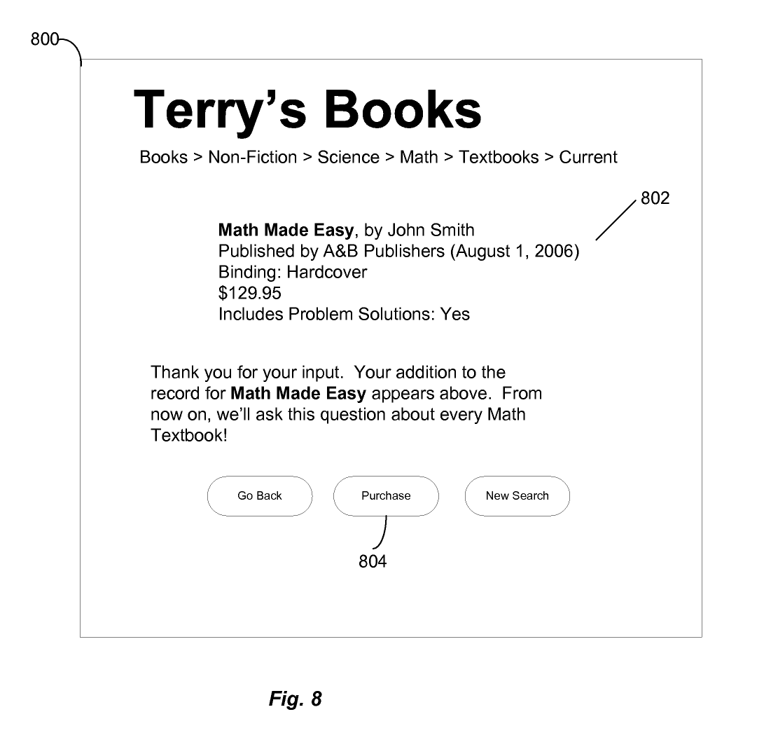

In FIG. 8, the updated record is displayed to the user in region 802, including the newly-added attribute and value. The user can click on a Purchase button 804 to immediately purchase the book, or can go back, conduct a new search, or otherwise navigate away from the page. Note that at no time during the described process did the user have to change to an administrative view of the database, nor was she even required to be aware that she was editing a database schema.

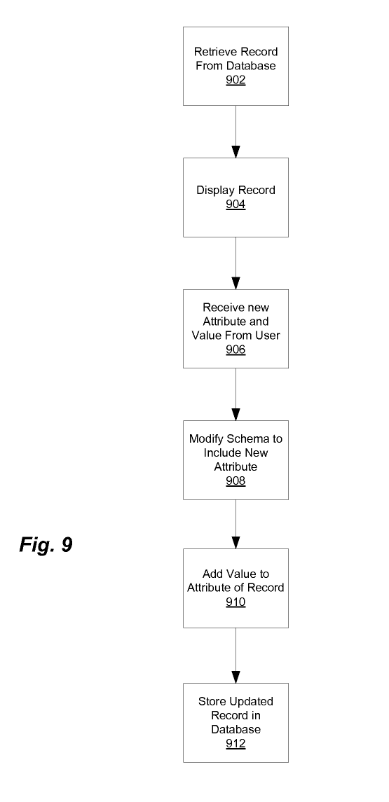

FIG. 9 is an illustration of one embodiment of a method for enabling a database user to extend the database schema.

Initially, a record is retrieved from the database 902. This retrieval takes place, for example, when user computer 110 makes a request for a web page displaying content of the type stored in database 104. Once retrieved, the record is displayed to the user 904. For example, server 102 obtains the record from the database, assembles a web page including the retrieved record and any other components of the page, and supplies the web page to user computer 110. Note that multiple records may be retrieved and displayed to a user in a single web page, though for clarity of description we describe a single record—no loss of generality is intended.

When a user of system 100 determines that she would like to extend the database schema, she supplies via user computer 110 a new attribute and value for the attribute. In the example described previously, the user determines that “Includes Problem Solutions” would be a useful attribute to include in records relating to math textbooks. The new attribute and value are received by server 102 and communicated in turn to taxonomy engine 106 at step 906. Also communicated to taxonomy engine 106 is an indication, for example a record ID, of the database record where the schema modification request was initiated—for example, the record a user was viewing when she selected a modification option.

In one embodiment, prior to modifying the schema, taxonomy engine 106 determines whether the user has permission to modify the schema. As will be understood by those of skill in the art, different users may be given different levels of access to extend the schema, including restrictions as to which portions of the schema can be extended. Taxonomy engine 106 accordingly determines, for example by reference to a user's account information and the security policy settings for the schema, whether the user is entitled to perform the requested modification. Once taxonomy engine 106 has determined that the user is entitled to perform the modification, it implements the modification by adding the new attribute to the schema 908. Taxonomy engine 106 also adds the value for the attribute supplied by user computer 110 to the record that originated the modification 910, and stores the updated record in the database 912. In one embodiment, values are left blank for other records to which the attribute is applicable. In another embodiment, the affected records are flagged for review so that a value can be supplied for each record, either by a system administrator or by other users of the system.

In one embodiment, users are allowed to supply values to attributes that already have values. This is particularly useful in cases where an attribute is subjective—describing matters of opinion such as whether a store has “easy parking”, or “friendly staff”. When a record is displayed, in one embodiment a number or percentage of contributing users who have selected each value for an attribute is displayed. For example, “30% of users agree that this location has easy parking.” Alternatively, the record can display only a composite value for the attribute, determined according to a rule defined by a system administrator. For example, if an attribute requires a Yes/No response, in one embodiment the attribute will be set to “Yes” if more than 50% of respondents indicate “Yes”. If the attribute is of another type, such as numeric or free text, then a rule can be established for resolving attribute values during search, such that a value is “true” if more than a threshold number, e.g., 20%, of all values supplied for the attribute responses contain that value. Thus, if 20% of respondents indicate that a restaurant serves “Italian” food, then that restaurant will be displayed when a user searches for Italian restaurants. Note that 30% of respondents might have indicated that the same restaurant serves “Continental” food, and the restaurant would also show up in a search for restaurants serving Continental food. Accordingly, a restaurant can have attribute values that are “true” for multiple values. Composite values in one embodiment are stored in the database but do not replace the individual values supplied by users. These analytically-determined composite values may be updated and stored each time a new value is received for an attribute, or they may be determined in real time prior to being displayed or used for a search.

In one embodiment, system 100 enables searching of attribute values including those contributed by other users. For example, a user may be interested in locating all current math textbooks that include problem solutions, or all Italian restaurants with easy parking. Because some visitors to the Terry's Books web site might indicate that Math Made Easy includes problem solutions, while other visitors indicate that it does not include solutions, a composite value for the attribute as described above enables the search to proceed and return results consistent with the composite value rules. Thus, if a rule provides that the “Includes problem solutions” attribute should be true if more than 20% of contributing users indicate that it is true, then a search for math textbooks that include problem solutions will return Math Made Easy if more than 20% of contributing users have so indicated.

Because system 100 enables not just extension of the database schema but also additions to the taxonomy by contribution of attribute values, it is helpful to allow either manual or automatic override of the supplied values in some cases, particularly where the attribute describes a subjective measurement, such as whether restaurant staff is friendly.

In one embodiment administrators of system 100 and users of system 100 can assign relationships between different type values in order to recompress the type list and increase relevancy in searching. For example, for a “Food Type” attribute in a restaurant database, “Dutch” and “Netherlands” should be normalized to either one term or the other. If some reviewers choose “Dutch” and some choose “Netherlands” when assigning a value to the attribute, an assigned relationship of “Dutch=Netherlands”, set either by users or by an administrator will ensure that search results remain accurate and relevant.

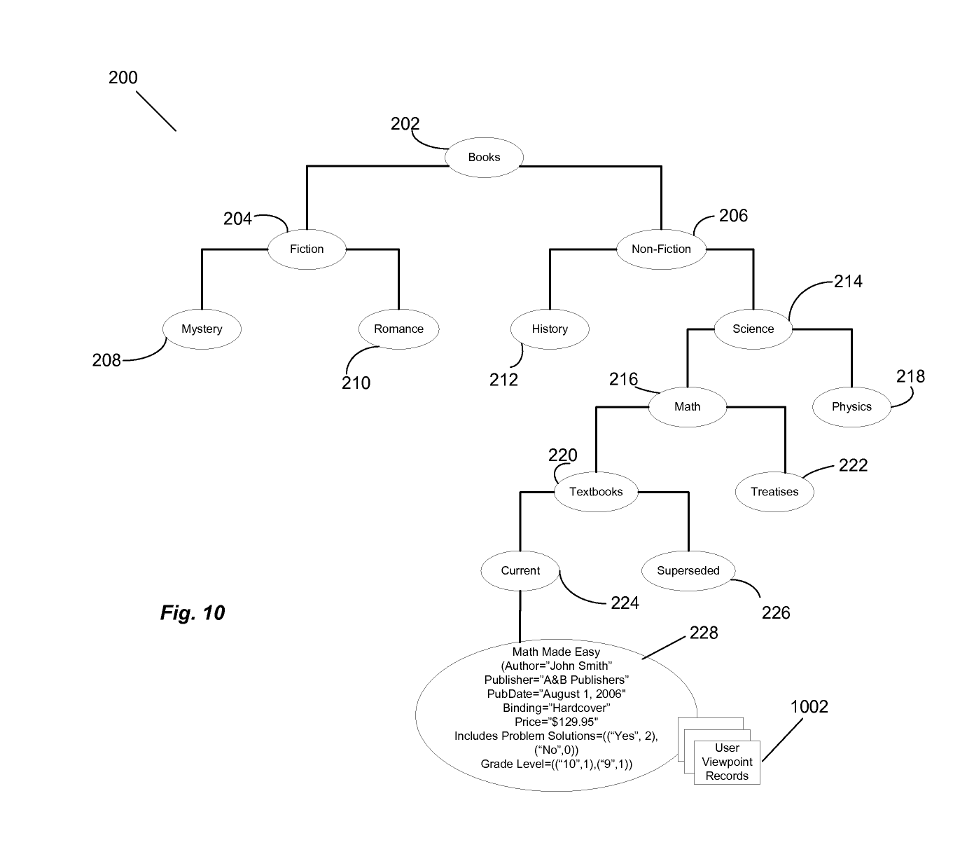

FIG. 10 illustrates an example of taxonomy 200 (FIG. 2) after having been extended by user contributions. In the illustrated case, additions to the taxonomy include the attributes of “Includes Problem Solutions” and “Grade Level”. As can be seen, in the case of Math Made Easy 228, two contributing users have indicated that “Includes Problem Solutions” has a value of “Yes”, and none have indicated a value of “No”. One user has indicated that the grade level for the textbook is “9”, and one has indicated that it is “10”. FIG. 10 also illustrates a collection 1002 of the individual records contributed by users.

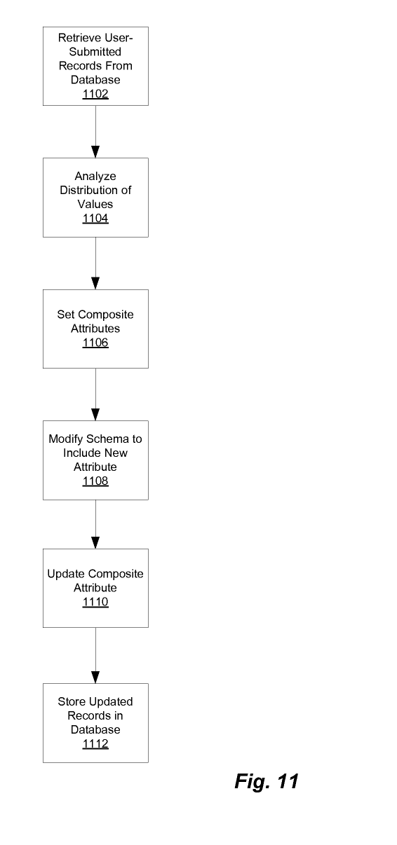

FIG. 11 represents an ongoing unattended or attended analysis process or as a process executed each time a user submitted viewpoint on a taxonomy is submitted to the taxonomy engine. In step 1102, system 100 retrieves user submitted records with attribute values from database 104 under a taxonomy node. In step 1104 system 100 analyzes the distribution of attribute values. In step 1106, system 100 sets composite attributes (such as “Yes” based on a criteria of more than x percent” either as absolute or as updated statistics, e.g., Value=147 Yes and 23 No's. In step 1108 the schema is modified to include any new supplied attributes. Finally, the composite attributes are updated in step 1110, and the records stored in step 1112.

The present invention has been described in particular detail with respect to a subset of possible embodiments. Those of skill in the art will appreciate that the invention may be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of this description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the, along with equivalent variations. In addition, the present invention is not described with reference to any particular programming language. It is appreciated that a variety of programming languages may be used to implement the teachings of the present invention as described herein, and any references to specific languages are provided for invention of enablement and best mode of the present invention.

The present invention is well suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

I claim:

1. A computer-implemented method for extending a database schema by a user other than a database administrator, the method comprising:
retrieving a record from a database, the record including at least one attribute defined by the schema;
displaying the retrieved record to a user;
receiving from the user a new attribute and a value for the new attribute;
modifying the schema to include the new attribute;
modifying the record to associate the value for the new attribute with the new attribute; and
storing the record in the database.

2. The method of claim 1 further comprising:
receiving from a second user a second value for the new attribute; and
modifying a composite value for the attribute of the record, the composite value determined based on all received values for the attribute of the record.

3. The method of claim 2 further comprising displaying the record including the modified composite value.

4. The method of claim 2 further comprising:
receiving from a third user a search query, the query specifying a query value for the new attribute;
responsive to the composite value for the attribute of the record matching the query value, displaying to the user the record including the composite value.

5. The method of claim 1 further comprising:
identifying a second record in the database having the new attribute;
obtaining for the second record a value for the new attribute.

6. The method of claim 5 wherein the value for the new attribute for the second record is obtained from the user.

7. The method of claim 5 wherein the value for the new attribute for the second record is obtained from a different user.

8. A system for extending a database schema by a user other than a database administrator, the system comprising:
a server computer for communicating with a user computer to display database records to a user and to receive from the user modifications to the database schema;
a taxonomy database for storing records, each record including at least one attribute defined by the database schema;
a taxonomy engine, coupled to the server computer and the taxonomy database, adapted to:
receive a new attribute and a value for the new attribute, the attribute and value supplied by the user computer;
modify the schema to include the new attribute;
modify the record to associate the value for the new attribute with the new attribute; and
store the record in the database.

9. The system of claim 8 wherein the taxonomy engine is further adapted to:
receive from a second user a second value for the new attribute; and
modify a composite value for the attribute of the record, the composite value determined based on all received values for the attribute of the record.

10. The system of claim 8 wherein the taxonomy engine is further adapted to:
identify a second record in the database having the new attribute; and
obtain for the second record a value for the new attribute.

11. The system of claim 10 wherein the value for the new attribute for the second record is obtained from the user computer.

12. The system of claim 10 wherein the value for the new attribute for the second record is obtained from a second user computer.

13. A computer program product for extending a database schema by a user other than a database administrator, the computer program product stored on a computer-readable medium and including program code configured to cause a processor to carry out the steps of:
retrieving a record from a database, the record including at least one attribute defined by the schema;
displaying the retrieved record to a user;
receiving from the user a new attribute and a value for the new attribute;
modifying the schema to include the new attribute;
modifying the record to associate the value for the new attribute with the new attribute; and
storing the record in the database.

14. A computer-implemented method for extending a database schema by a user other than a database administrator, the method comprising:
receiving at a web server a request from a user of a web browser to display a record of a database;
retrieving the requested record from the database, the record including at least one attribute defined by the schema, and displaying the record in the user's web browser;
receiving from the user a request to add a new attribute and a value for the new attribute to the record;
modifying the database schema to include the new attribute received from the user;
modifying the retrieved record to associate the value received from the user for the new attribute with the new attribute;
storing the modified record in the database; and
displaying the modified record in the user's web browser.
